(19) United States
(12) Patent Application Publication
(10) Pub. No.: US 2019/0343089 A1
(43) Pub. Date: Nov. 14, 2019

(54) HONEY EXTRACTOR THAT DOES NOT GENERATE FOAM

(71) Applicant: XNOX S.A. de C.V., El Llano (MX)

(72) Inventor: Rene PINEDO MIRAMONTES, El Llano (MX)

(73) Assignee: XNOX S.A. de C.V., El Llano (MX)

(21) Appl. No.: 16/468,842

(22) PCT Filed: Dec. 18, 2016
(86) PCT No.: PCT/MX2016/000133

§ 371 Date: Jul. 22, 2019

(51) Int. Cl. A01K 59/04

(52) U.S. Cl. CPC A01K 59/04

(57) ABSTRACT

The present invention describes a honey extractor that allows to reduce the generation of foam or micro foam, as well as allowing the honey leaving the hexagons of the frames to be free of wax residues, so that the honey leaving the extractor of honey that does not generate foam goes directly to the packaging containers, without the need to go through another process and/or machine. An advantage of the honey extractor motive of the present invention is that its parts are removable, which makes the transfer to other places not complicated, as well as the maintenance is faster and less expensive.

### TECHNICAL FIELD OF THE INVENTION

The present invention relates to the technical field of the mechanics, fluid dynamics, beekeeping and more specifically with the processing of foods such as honey; since it contributes Extractor one honey that does not generate foam.

### BACKGROUND OF THE INVENTION

A honey extractor is a centrifuge whose shaft can work vertically or horizontally. In it the movable frames are placed with the combs of wax that contain the honey, by centrifugal force, this leaves the hexagonal cells of the combs stamping against the walls of the machine. The inventor of the honey extractor was Francesco De Hruschka in 1883.

In a meeting of the Beekeeping Association of Brunnen (Brno) in 1865, which was attended by personalities such as Gregorio Mendel exhibiting work in 1871, and the Paris Insect Exhibition in 1868, De Hruschka presented a tangential honey extractor powered by straps. His inspiration came from observing his son who was rolling some combs in a basket over his head. The honey extractor was presented under the trade name De Hruschka who was Angelo Lessane, Dolo, Venice.

In 1873 FR Cheshire described this machine as an adaptation of the centrifugal dryer, consisting of a wooden tub inside which rotated a perforated metal cage with the upper end open. The inner cage was swiveled at the beginning by a rope, but in later models by an endless belt of a transmission wheel.

Shortly after being observed this extractor in England and the United States there were variations of this machine, replacing the wooden tub, by tinplate with all possible combinations of moving parts and inner and outer drums, equipment to invert the moving frames with the honeycombs no need to remove them from the cage, and variations in the cage. These adaptations continue to this day, following the same principle of extraction of honey, which is the centrifugal force.

That is why we can attribute to Francesco De Hruschka, the invention of centrifugal honey extractor. The importance of this discovery is crucial for the development of beekeeping, because it is no longer necessary to destroy the honeycomb to obtain honey, which stops the best beehives to obtain the product. It is undoubtedly an invention associated with the appearance of Lorenzo Langstroth's mobile painting.

There has been an evolution in this type of machinery over time, at first, they were manual and for two or four frames, usually sheet metal. Nowadays they have a large capacity of frames (between 80 and 120) for the purpose of doing more work, presenting speed controllers, baskets that allow fast loading, powerful motors, auto systems braking, and are usually built in special stainless steel for the food industry. Once the honey is collected in the extractor or in a stainless-steel pit, by means of pumps or pallets it is sent to decanters, or directly to the drums.

A honey centrifuge or extractors are already known and extensively used, comprising a rotating center, a rotor, in a vertical or horizontal position, composed of a main or fixing axis, which passes through the shield or body, where the torsion is provided to generate the rotating movement, and that is fixed to a basket, support or cage, where the frames containing the honeycombs are placed. The frames or combs may be arranged, with respect to the axis, radially or face-to-face. The body or shield that surrounds this rotor, usually has a cylindrical shape, and is static. When the rotor is in operation, the frames, combs and operculums rotate together, causing honey to be expelled from the combs with speed, by centrifugal force. The honey is thrown against the static wall of the body or shield suffering a blow, as soon as the speed falls to zero, in a reduced time interval. The honey is sprayed in several small drops due to the impact.

A search was made of the state of the art of HONEY EXTRACTORS THAT DO NOT GENERATE FOAM and several documents were found, for example, the patent application number ES2384508 (T3), entitled “INTEGRAL CENTRIFUGE HONEY RACKS, honeycombs and opercula AND PROCESS FOR EXTRACTING HONEY” published on Jul. 6, 2012, the document discloses a rotary machine for extracting honey from honeycombs, cappings, racks and the like, for use in beekeeping farms, honey stores and the like, in order to extract the honey while retaining the same characteristics and original composition of the honey found in the combs and frames of the hives, and a process to extract the honey using said equipment. The centrifuge or honey extractor links the basket or support or cage to the main or fixing axis, and finally, to the body or shield, forming a single, single-block assembly that rotates. The main shaft can be arranged vertically, as well as horizontally, the start-up can be manual or motorized, the frames or combs can be arranged, with respect to the center, in radial or face positions, and closed with a cover. In the upper part or upper end of the body or shield of the centrifuge, where the frames or honeycombs are placed, there must be a bar, wing or inner edge conveniently calculated and higher than the body or shield to prevent honey, which is on the inner wall when it is in operation, overflows and spills outside the equipment. This bar, wing or inner edge must be part of the body or shield to avoid contamination and facilitate the cleaning of the equipment. The increase of humidity, the production of foams and micro-foams, the release of volatile enzymes, oxidation and fermentation due to the extraction process and the blows, are reduced to zero. Once the equipment is in operation, the honey that comes out of the alveoli, honeycombs, opercula or similar, runs down the body wall or shield, which is also rotating at the same speed as the frames, honeycombs, opercula or similar, and is contained by the wall until the movement ceases. The relative speed between the wall, body or shield and the frames, honeycombs, honey lids or the like is zero. When the rotor of the centrifuge stops rotating, the effect on the frames or honey combs and on the honey that is on the wall or shield due to the centrifugal force ceases. The honey drains to the bottom where a collector with a drain or outlet for honey is located. During the entire process of extraction or centrifugation, the honey is extracted without being hit or shocked, since there is no abrupt deceleration, neither undergoes any aeration nor pulverization, conserving all its integrity, without any alteration in the flavor and preserving it during much more time, delaying the start of fermentation, conserving the relative humidity and the original volatile enzymes.

Another document found is 1 to patent application United States publication number U.S. Pat. No. 3,011,646 (A), published on Dec. 5, 1961, which aims to provide means for discharging honey combs in receptacles or individual containers instead of in a common receptacle as in conventional honey extractors, so that pieces of comb or cap that can break are confined to a receptacle and prevent mix with all the mass of extracted honey; means the use of containers or individual containers in the extractor is possible to separate the individual hives honey and even individual combs without mixing with a common mass of honey. Therefore, honey that may have accumulated in a certain beehive, which gathered from certain flowers, can be kept separate from honey of a different type and quality accumulated in another hive while removing all Honey can be made at the same time and in the same machine. Said machine honey extraction, comprising a rotatable support in a horizontal plane, a plurality of mounted containers detachably on said support, each of said containers having two vertical sidewalls, a partially cylindrical inner wall close a Concentric to the partially cylindrical outer wall with the inner wall, a flat horizontal lower wall, inner, outer and lower walls are joined together to form a closed wedge-shaped body with an open top, a cover hingedly mounted on the outer wall and having a shorter length than the bottom wall to provide a partial closure with an air outlet in the upper part of the container when the lid is closed on the side and outer walls; and a load carrier for a removable honeycomb, arranged in each of the containers, the load carrier comprises a pair of horizontal outer bars extending in one direction, a pair of inner horizontal bars extending in the same direction, being the outer bars longer than the interior ones; a pair of parallel horizontal bars that link bar external horizontal bars and a bar of the inner horizontal bar and extending perpendicularly to the first, called horizontal bar, a pair of parallel horizontal bars s that link the other of the outer horizontal bars and the other of the horizontal bars, this last pair of joints in the bars arranged in the same direction as the first pair of tie bars, the tie bars being of equal length and spaced inwardly from the ends of pairs of horizontal bars, the bars extend through the bars of lower attachment that provide a support for a honeycomb in a vertical plane, the lower tie bars spaced upwards from the bottom of the vertical bars to provide a space for collecting honey in the bottom of the container below the honeycomb.

One of the main drawbacks of the equipment for extracting honey is the production of foam and/or micro foam, which may result in accelerated fermentation and taste alterations, causing the inspection agencies to reject some batches of honey produced. Once the honey is extracted, it is necessary for the honey to pass through a pump, to a team called SPINNER which makes a separation process of the wax residues that the honey has, to later be able to pack the honey free of wax by means of dispensers.

While it is true, there are already honey extractors, and those described above can be seen that reduce the generation of foam or micro foam; but none of the above documents allows the honey out of said extractor is free of wax residues, nor describe honey leaving said extractors goes directly to packaging containers, without passing through another process and/or machine. Another disadvantage of honey extractor that are currently known is that they are manufactured with pieces that are not removable, which makes the transfer to other places is complicated, as well as the maintenance is slower and more expensive. The process of extraction of honey needs, at least, a deodorant, an extractor, a centrifuge for operculum, a sedimentation tank and two pumps, so that the honey is in packaging conditions for commercialization.

### OBJECT OF THE INVENTION

It is therefore the object of the present invention to provide a honey extractor that does not generate foam, that solves the problems described above.

### BRIEF DESCRIPTION OF THE FIGURES

The characteristic details of this and honey extractor that does not generate foam, they are shown clearly in the following description and the accompanying figures, and an illustration of the one, and following the same reference signs to indicate the parts shown. However, said figures are shown by way of example and should not be considered as limiting for the present invention.

FIG. 1 shows a right perspective honey extractor which does not generate foam.

FIG. 2 shows a front view of the honey extractor that does not generate foam.

FIG. 3 shows a left perspective view of the honey extractor that does not generate foam.

FIG. 4 shows a right side view of the honey extractor that does not generate foam.

FIG. 5 shows a top view of the honey extractor that does not generate foam.

FIG. 6 shows a bottom view of honey extractor that does not generate foam.

FIG. 7 shows a detailed view of the centrifugal tub with the frames secured by means of the upper separators of the honey extractor that does not generate foam.

FIG. 8 shows a detailed view of the interior of the centrifugal vat with the frames secured by means of the lower separators of the honey extractor that does not generate foam.

FIG. 9 shows a perspective view of the centrifugal vat of the honey extractor that does not generate foam.

FIG. 10 shows a side view of the centrifugal vat of the honey extractor that does not generate foam.

FIG. 11 shows a detailed view of the lower separators of the honey extractor that does not generate foam.

FIG. 12 shows a perspective view of the honey extraction hopper of the honey extractor that does not generate foam.

FIG. 13 It shows a top view of the tub, where the honey extractor movement transmission system that does not generate foam is appreciated.

FIG. 14 shows a view of the longitudinal section of the honey extractor that does not generate foam, in which the arrow mounted on a journal and an upper bushing can be seen.

FIG. 15 shows a top perspective view of the honey extractor that does not generate foam, where the uncapped knife and the operculum extractor can be seen.

FIG. 16 shows a detail extractor operculum honey extractor does not generate foam.

### DESCRIPCION DETALLADA DE LA INVENCION

For a better understanding of the invention, below, the parts that make up the honey extractor that does not generate foam are listed:
1. Structure
2. Legs
3. Support crossbars
4. Slots
5. Corner boards
6. Centrifugal tub
7. Bottom separators
8. Top separators
9. Inertia flywheel
10. Fixed tubes
11. Upper bushing
12. Lower bushing
13. Axis
14. Rowlock
15. Honey separating hopper
16. Mesh
17. Hopper receiving honey
18. Exit hole
19. Containers
20. Safety hopper
21. Top
22. Gate
23. Fixed center
24. Engine
25. Pulley
26. Band
27. Deodorizing knife
28. Knife base
29. Resistances
30. Ophthalmologist
31. Lever
32. Actuator spring

With reference to the figures, the honey extractor that does not generate foam is composed of:

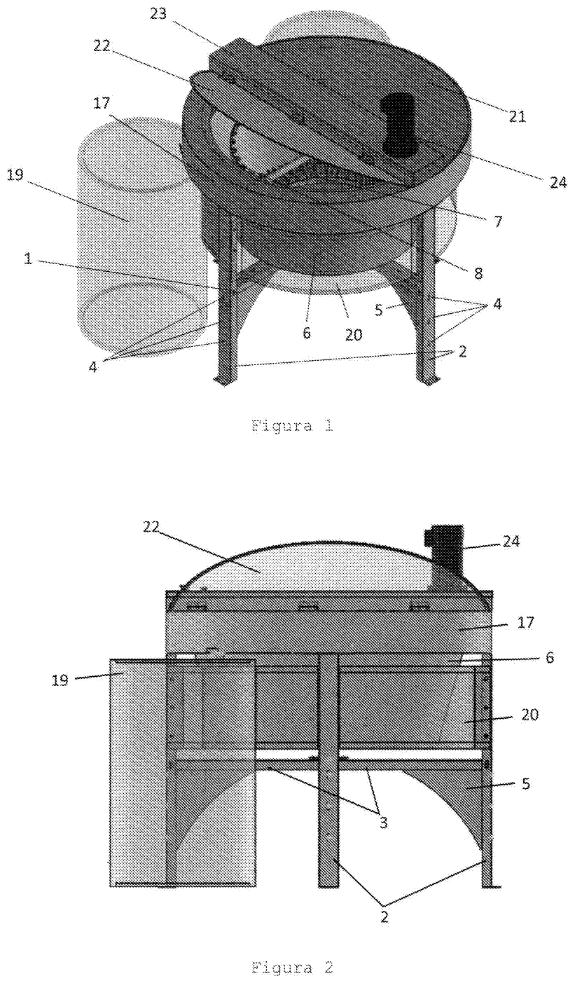

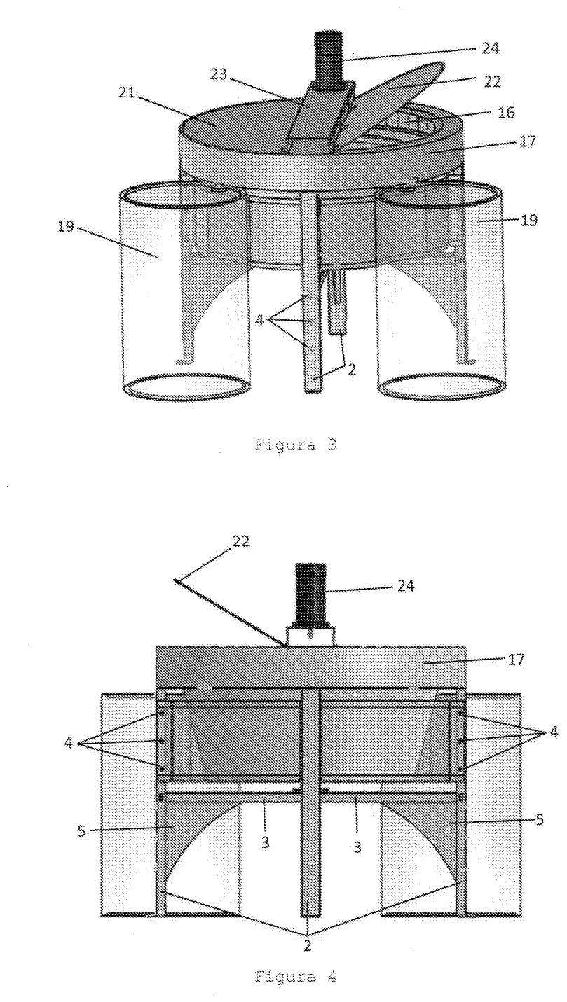

A structure (1) formed by at least four legs (2) joined together by means of support crosspieces (3), the legs and crosspieces are configured with various slots (4) that allow by means of fastening (not illustrated)) the assembly between them at their point of union, helping to regulate the height of the support crosspieces (3) and distance between the legs (2), said slots (4), allow a corner board (5) to be assembled between each leg (2) and support cross member (3), which gives greater support to the structure (1), as shown in FIGS. 1, 2, 3, 4, 6 and 16.

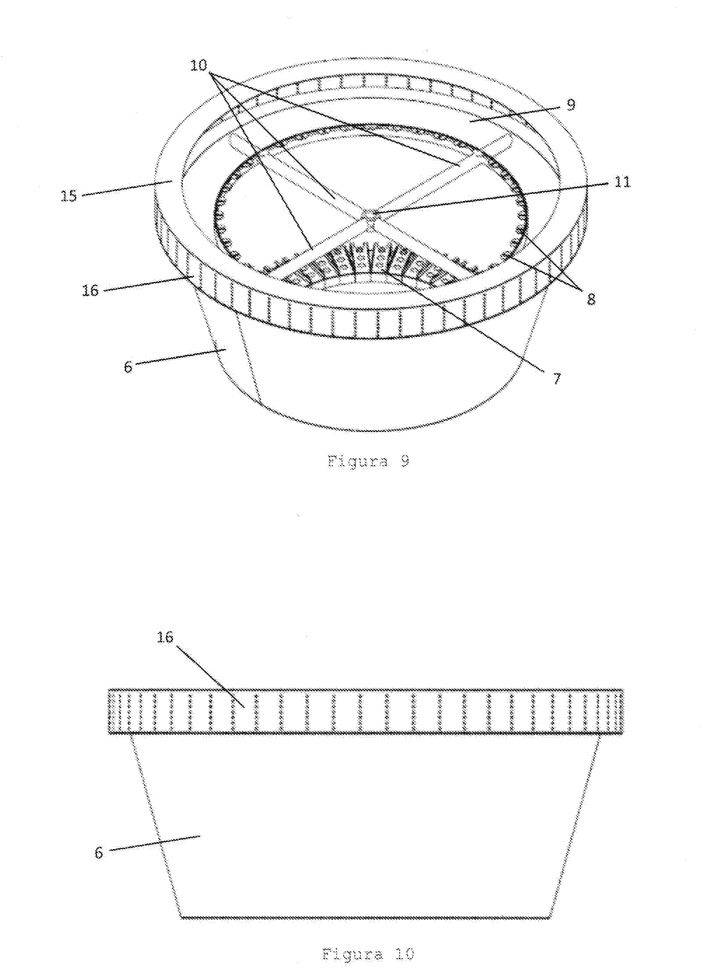

The structure (1) is configured to support a centrifugal vat (6) on the support rails (3), which as shown in FIGS. 9 and 10 has as its main characteristic that its walls have an inclination of 35 to 85 degrees, which allows the honey that is coming out of the hexagons of the frames to rise thanks to the rotary movement of the centrifugal tub (6) to a honey separating hopper (15); this configuration of the centrifugal vat (6) allows the honey that is rising does not generate foam.

The centrifugal vat (6) has in its lower part bottom spacers (7) and in the upper part, with a flywheel (9) that has in its circumference upper spacers (8) which hold and secure the frames to which the honey will be extracted.

The flywheel (9) has at least four fixed tubes (10) attached to the center by means of an upper bushing (11), on which a shaft (13) is placed which is fixed on the lower part of the bushing (11). The centrifugal vat (6) by means of a lower bushing (12) which is joined to a journal (14) placed in the structure (1) under the centrifuge tub (6) fixed on the support crossbars (3), which allows that centrifugal vat to rotate.

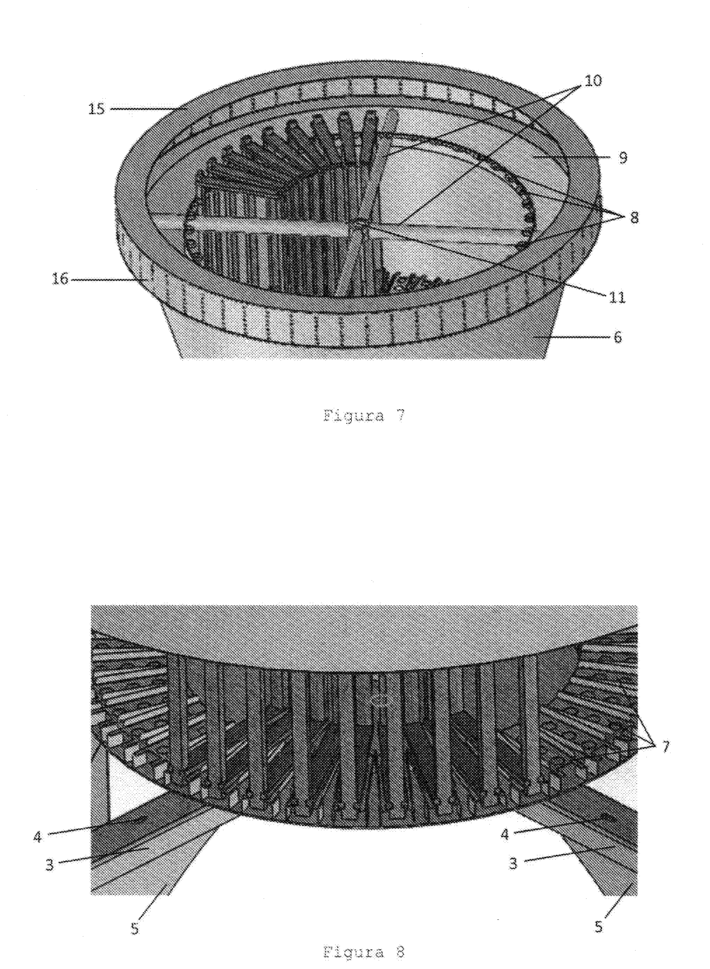

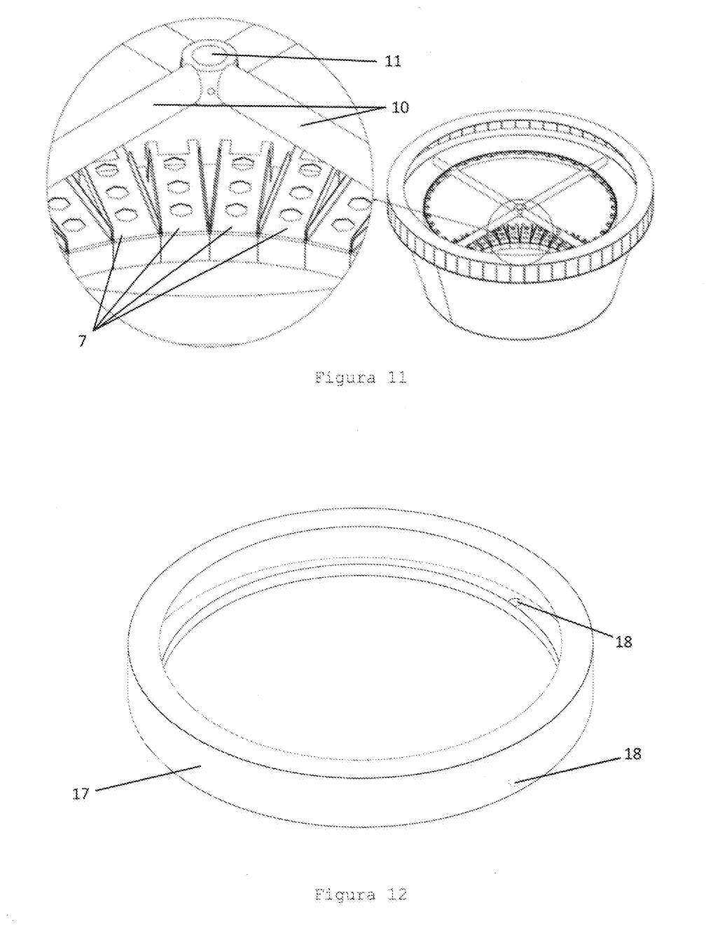

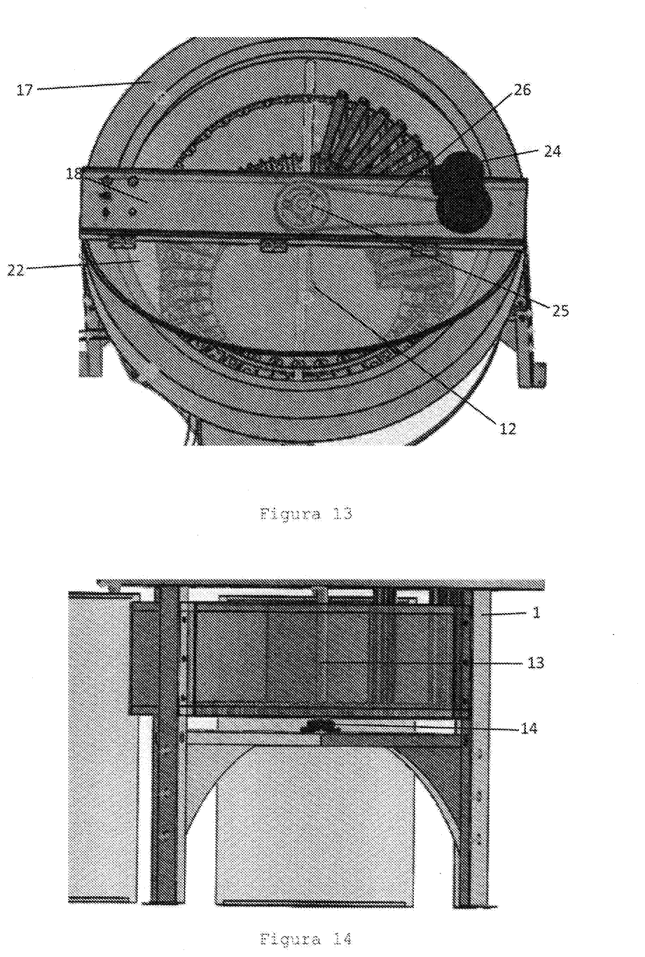

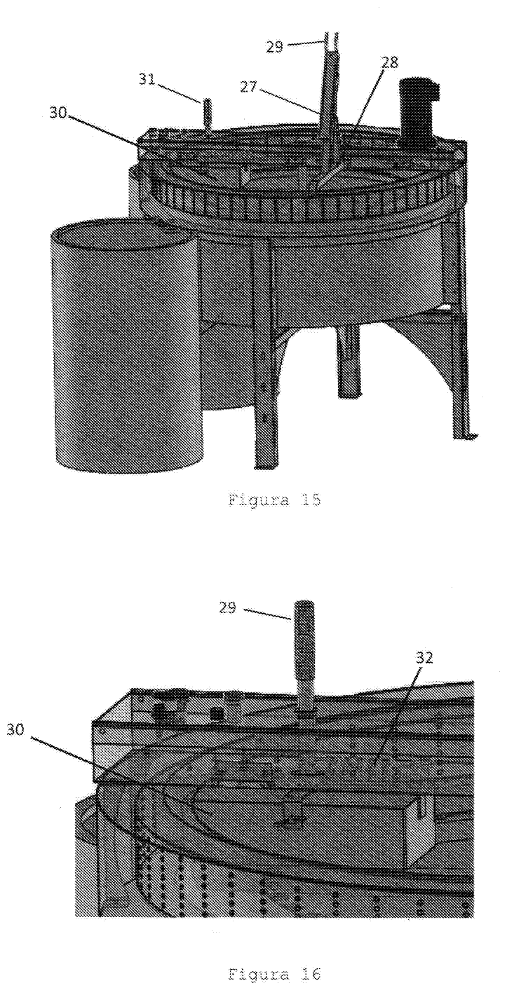

As shown in FIGS. 7, 8, 9, 11 and 13, the lower spacers (7) and the upper spacers (8) are placed parallel to each other equidistantly and are configured to hold and secure in a stable manner a Stable way the frame with honey. The lower separators (7) have an inclination so that the frame is recharged in the kite and the extraction of honey is easier and faster.

The centrifugal tub (6) has in its upper part, on the flywheel (9), a honey separating hopper (15) which rotates together with the centrifugal tub; said honey separating hopper has in its circumference a mesh (16) with multiple perforations interspersed with each other, through which the honey passes once it is extracted from the frames, causing it to separate from the wax residues it may contain.

As illustrated in FIG. 12, a honey receiving hopper (17) covers the honey separating hopper (15) and is fixed on the upper part of the legs (2); this honey receiving hopper (17) is the one that receives and where the honey that has already passed through the mesh (16) is falling, and by means of, at least, an exit hole (18) so that the honey is already clean that comes out of the mesh so it has some grooves or exits where the honey is coming from. Below each outlet (18), a container (19) is placed, in which the honey is deposited, extracted from the frames, free of wax and foam, ready for consumption and commercialization.

Some safety hoppers (20) are assembled on the circumference of the centrifugal tub (6) fixed to the slots (4) of the legs (2) by fastening means (not illustrated), the safety hoppers (20) are to avoid an accident while the honey extractor that does not generate foam is in operation.

The fastening means (not illustrated) that are used in the honey extractor that does not generate foam, can be screws, bolts, rivets, welding, presses, threaded elements, tongue and groove mechanisms and/or the combination of the above.

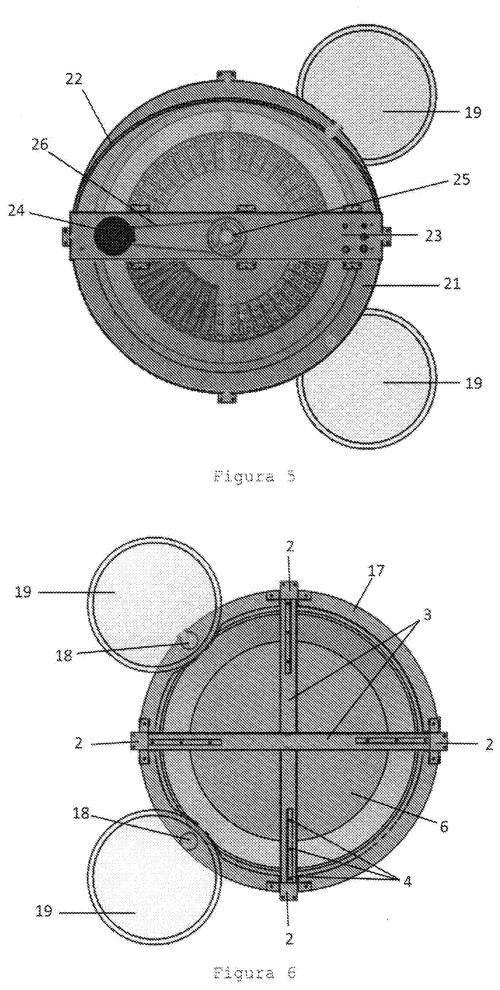

As shown in FIGS. 1 to 5 and 13, the honey extractor that does not generate foam, in its upper part on the honey receiving hopper (17) is placed a lid (21), which is configured with, at least, a gate (22) and with a fixed center (23) on which a motor (24) is placed at either end and by means of a band (26) connected to said motor, moves a pulley (25) transmitting the movement to the shaft (13) to rotate the centrifugal tub (6).

Referring to FIGS. 17 and 18 the honey extractor that does not generate foam, has a uncapped knife (27) which is on a base knife (28) which is fixed on the fixed base (23) and base of the honey receiving hopper (17), said dithering knife (27) has, at least, a resistance (29), which warms the knife (27), to later pass the frame or honeycomb full of honey, and removes r the operculum that covers or protects honey from each of the honeycomb hexagons.

The honey extractor that does not generate foam, has an exhaust cover (30) fixed below the fixed center (23) together with the mesh (16), and is operated by a lever (31) which returns to the original location, thanks to an actuator spring (32), the exhaust cap (30) joint the entire wax which was stored and separated from honey and stays in the mesh (16), allowing opening it and that honey can pass through said mesh (16) without problem.

1. A honey extractor that does not generate foam, characterized by comprising:
i. A structure (1), formed by at least four legs (2) configured with different slots (4);
ii. support crossbars (3) configured with various grooves (4), are joined to the legs (2) at their points of attachment by fastening means placed through the grooves (4);
iii. a corner board (5) is assembled between each leg (2) and support crossbars (3) by means of the slots (4);
iv. a centrifugal tub (6) that its walls have an inclination, is supported on the support crossbars (3);
v. some lower spacers (7) are inside the centrifugal tub (6) in its lower part;
vi. a flywheel (9) with at least four fixed tubes (10) attached to the center by means of an upper bushing (11), is located at the top of the centrifuge tub (6);
vii. some upper spacers (8) is located on the circumference of the flywheel (9);
viii. an axle (13) is placed on the upper bushing (11) and fixed to the lower part of the centrifugal tub (6) by means of a lower bushing (12) which is joined to a journal (14) placed under the centrifugal tub (6);
ix. a honey separating hopper (15) has in its circumference a mesh (16) with multiple perforations, it is fixed in the upper part of the centrifugal tub (6) on the flywheel (9);
x. a honey receiving hopper (17) having at least one outlet hole (18), covers the honey separating hopper (15);
xi. some safety hoppers (20), are assembled in the circumference of the centrifugal tub (6) fixed to the slots (4) of the legs (2) by means of restraint;
xii. a lid (21) configured with at least one gate (22) and with a fixed center (23), is placed on the upper part of the honey extractor that does not generate foam on the hopper receiving honey (17);
xiii. a motor (24) is placed on either end of the fixed center (23) of the cover (22);
xiv. a band (26) connected to the motor (24), moves a pulley (25) which transmits the movement to the shaft (13);
xv. an uncapping knife (27) on a knife base (28) is fixed on the fixed center (23);
xvi. at least one resistance (29) is placed on the uncapped knife (27); y,
xvii. an operculum extractor (30) that is actuated by means of a lever (31) which returns to its place of origin, with an actuating spring (32); is fixed below the fixed center (23) next to the mesh (16).

2. The honey extractor of the preceding claim, wherein the inclination of the walls of the centrifugal vat (6) is from 35 to 89 degrees.

3. The honey extractor according to claim 1, wherein the journal (14) is placed in the structure (1) on the support crossbars (3).

4. The honey extractor according to claim 1, wherein the lower spacers (7) and the upper spacers (8) are placed parallel equidistant from each other.

5. The honey extractor according to claim 1, wherein the lower spacers (7) have an incline.

6. The honey extractor according to claim 1, wherein the perforations of the mesh (16) is n interleaved together.

7. The honey extractor according to claim 1, wherein the honey receiving hopper (17) is fixed on the upper part of the legs (2).

8. The honey extractor according to claim 1, wherein under each outlet hole (18), a container (19) is placed.

9. The honey extractor according to claim 1, wherein the fastening means may be screws, bolts, rivets, welding, presses, threaded elements, tongue and groove mechanisms and/or the combination of the foregoing.
